(19) United States
(12) Patent Application Publication
(10) Pub. No.: US 2023/0383903 A1
(43) Pub. Date: Nov. 30, 2023

(54) Quick Extension Hooks

(71) Applicants: Jason R. Cordova, Lake Mary, FL (US); Michael B. Cordova, Lake Mary, FL (US)

(72) Inventors: Jason R. Cordova, Lake Mary, FL (US); Michael B. Cordova, Lake Mary, FL (US)

(21) Appl. No.: 18/318,517

(22) Filed: May 16, 2023

Related U.S. Application Data
(60) Provisional application No. 63/345,257, filed on May 24, 2022.

(51) Int. Cl. F16M 13/02; G09F 17/00

(52) U.S. Cl. CPC F16M 13/022; G09F 17/00; G09F 2017/0041

(57) ABSTRACT

A hook device is disclosed. The device comprises a body portion having a strap bent to form a loop; a hook portion connected to one of the ends of the body portion; and an elongated member connected to one of the ends, opposite to the end connected to the hook portion.

### FIELD OF THE INVENTION

The present invention generally relates to a hook device. More specifically, the present invention relates to a novel device with a hook and an elongated member for use in installing banners/windscreens to a fence or similar structure.

### BACKGROUND OF THE INVENTION

A convenient device for installing banners/windscreens on a fence or similar structure is in demand.

Carabiners are used for various applications in many different activities, being a vital piece of equipment in climbing and other rope-related activities, used to keep rope users safe and secure. Carabiners can be used for a variety of outdoor recreational activities, such as rock climbing, mountaineering, and mountain rescue work. They can also be used in rescue work and as safety restraints in urban and industrial settings. Many different carabiners are available on the market, in a range of shapes, sizes, and colors.

Generally, carabiners are made from aluminum, so that they are lightweight without compromising strength and durability. Carabiner D clips are also used to hang banners/windscreens with grommets onto chain link fencing—currently the only method available on the market of doing so. However, such an approach takes a great deal of time and effort. As many as 130 carabiner D clips might be used for such a task, requiring the use of ladders to reach the top of chain link fencing 6 feet and higher—not only for setup but also for takedown. Because the combined task of climbing a ladder 260 times raises safety concerns while also consuming a great deal of time, a device is needed to solve these problems.

The present invention is intended to address problems associated with and/or otherwise improve on conventional systems and devices through an innovative hook device that is designed to provide a convenient and effective means of installing banners/windscreens with grommets onto structures such as chain link fencing and later taking them down, while incorporating other problem-solving features.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a hook device is disclosed. The device comprises a body portion having a strap bent to form a loop; a hook portion connected to one of the ends of the body portion; and an elongated member connected to one of the ends, opposite to the end connected to the hook portion.

In one embodiment, the hook device includes an elongated rod connected to the hook portion.

In some embodiments, the elongated member and one of the ends, opposite to the end connected to the hook portion, are angularly connected at acute angles.

In some other embodiments, the hook portion is connected to a telescopic pole.

### BRIEF DESCRIPTION OF THE DRAWINGS

FIG. 1 is an illustration of one embodiment of the present invention.

FIG. 2 is an illustration of one embodiment of the present invention with a cable tie around the body member.

FIG. 3 is an illustration of one embodiment of the present invention installed in a windscreen with grommets.

FIG. 4 is an illustration of an alternative embodiment of the present invention installed in a windscreen with grommets.

### DETAIL DESCRIPTIONS OF THE INVENTION

All illustrations of the drawings are for the purpose of describing selected versions of the present invention and are not intended to limit the scope of the present invention.

The present invention provides custom hooks that eliminate the need to use ladders to hang curtains and banners/windscreens with grommets onto suspension wiring and or chain link fencing (which can be from 3 feet to 17 feet high). These suspended screens must have grommets to allow use of this custom hook attachment.

The present invention can support banners/windscreens with grommets by using the grommets that are already installed on all fence windscreens.

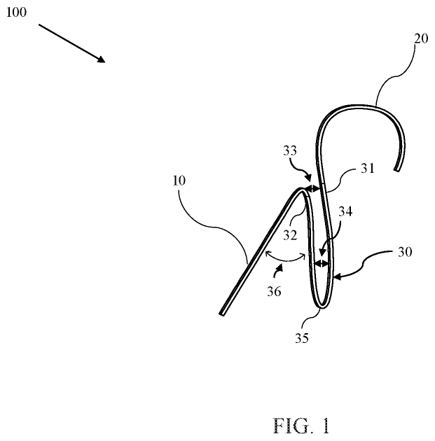

As FIGS. 1-4 show, the present invention provides a hook device 100 that comprises a hook portion 20 connected to a body portion 30, and an elongated member 10 connected to the body portion 30.

In preferred embodiments of the present invention, which may be portable embodiments as shown in FIG. 1, the body portion 30 can be U-shaped, with the bottom end of the hook portion 35 connected to one end of the U shape so that the hook portion 20 and the U-shaped body portion 30 can form an S-shaped structure.

In some embodiments, the body portion 30 can be a strap bent to form a loop terminating in two opposed, flat ends 31, 32 that can be brought together in an overlying relationship, wherein the loop defines a first distance 33 and a second distance 34. The first distance 33 is smaller than the second distance 34 so that the loop can securely hold a curtain ring, eyelet or similar objects inserted in the loop and exserting downward force on the bottom side of the loop. The loop (body portion 30), in some embodiments, can be configured to support eyelets of strip curtains or industrial art work.

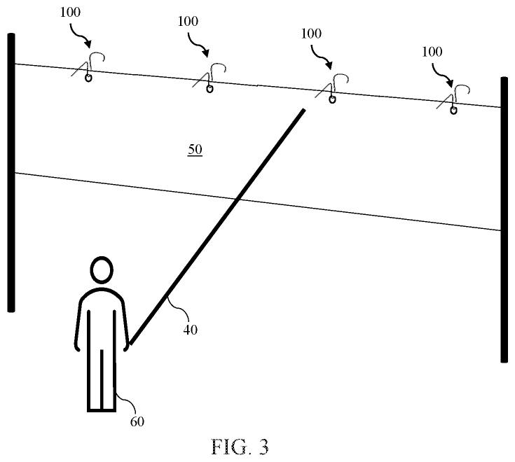

The elongated member 10 can be connected to the other end of the U-shaped body at a suitable angle 36. In some embodiments, the point at which the elongated member 10 attaches to the U-shaped body 30 can be curved to provide a smooth connection. The elongated member 10 can be sufficiently long enough to be inserted into a hollow rod/poll 40 that can be used by a user 60 to lift a curtain or banner/windscreen, as shown in FIG. 3.

Each component of the hook device 100 can be made of metal, whether steel, aluminum, or alloy, or of molded plastic.

The hook portion 20 can be configured and sized so that the hook device 100 can remain attached to each grommet position within a banner/windscreen 50 so equipped and become an integral part of that banner/windscreen 50, as shown in FIG. 3.

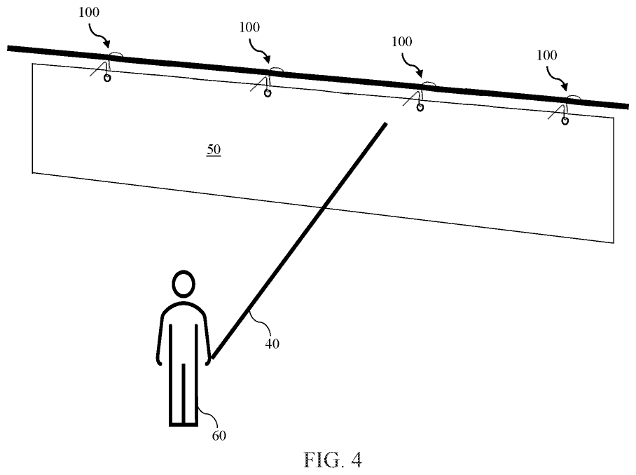

In some embodiments, the user 60 can put one end of the hook device 100 (the hook portion 20 or the elongated member 10) through the hole of the grommets so that the body portion 30 holds the banner/windscreen 50 with the hook portion 20 extending to one side of the banner/windscreen 50 and the elongated member 10 extending to the other side of the banner/windscreen 50 so that the hook portion 20 can engage the fence or any structure on which the banner/windscreen 50 is to be installed and the elongated member 10 can be used to raise or take down the banner/windscreen 50, as shown in FIG. 4.

The hook device can be designed with a unique feature useful for attaching it to the top of a fence without ladder support. For example, the elongated member can be attached to off-the-shelf adjustable/telescopic poles to reach heights of 6 feet to 17 feet. In another example, an extended rod which can be an off-the-shelf adjustable/telescopic pole (e.g., 8 feet in length) can include/be attached to the hook at the end, as shown in FIG. 4.

In some embodiments, the hook device 100 can be coated to protect against rust and to avoid damaging painted fencing.

The present invention can reduce banner/windscreen installation and takedown time by 70%-80%. Equally important, its use eliminates the tedious, physically demanding, and dangerous task of climbing ladders.

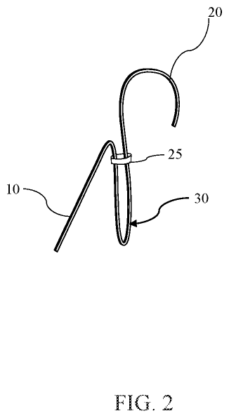

In some embodiments, the user 60 can apply a cable tie 25 or other fastener to the body portion to secure the hook portion 20 to the grommet when installed, as shown in FIG. 2.

In some other embodiments, the present invention can be made of bendable aluminum 6063-T5 (0.25″×0.125″×flat bar 102″ mill finish). This would reduce the weight of the hook load on banners/windscreens 50 from that encountered when using steel hooks, while allowing easier hand fabrication of hooks and the addition of coating dip.

The present invention can be fabricated from any type of material and can be extended (using a longer hook) to accommodate various hard-to-reach heights without requiring the use of ladders. In some cases, a square pole 40 extension would be the only tool needed to attach banners/windscreens 50 with grommets to fence tops.

Although the invention has been explained in relation to its preferred embodiment, it is to be understood that many other possible modifications and variations can be made without departing from the spirit and scope of the invention.

The following is claimed:

1. A hook device comprising,
a body portion having a strap bent to form a loop terminating in two opposed flat ends that can be brought together in an overlying relationship, the loop defines a first distance and a second distance;
a hook portion connected to one of the flat ends of the body portion; and
an elongated member connected to one of the flat ends, opposite to the flat end connected to the hook portion.

2. The hook device as claimed in claim 1, further includes an elongated rod connected to the hook portion.

3. The hook device as claimed in claim 1, wherein the first distance is smaller than the second distance.

4. The hook device as claimed in claim 1, wherein the elongated member and the one of the ends, opposite to the end connected to the hook portion, are angularly connected at acute angles.

5. The hook device as claimed in claim 1, wherein the body portion, the hook portion, and the elongated member are made of aluminum material.

6. The hook device as claimed in claim 1, wherein at least a portion of the hook device is coated.

7. The hook device as claimed in claim 1, wherein the hook portion is connected to a telescopic pole.

8. A hook device comprising,
a body portion having a strap bent to form a loop terminating in two opposed ends that can be brought together in an overlying relationship, the loop defines a first distance and a second distance;
a hook portion connected to one of the ends of the body portion; and
an elongated member angularly connected to one of the ends, opposite to the end connected to the hook portion.

9. The hook device as claimed in claim 8, further includes an elongated rod connected to the hook portion.

10. The hook device as claimed in claim 8, wherein the first distance is smaller than the second distance.

11. The hook device as claimed in claim 8, wherein the elongated member and the one of the ends, opposite to the end connected to the hook portion, are angularly connected at acute angles.

12. The hook device as claimed in claim 8, wherein the body portion, the hook portion, and the elongated member are made of aluminum material.

13. The hook device as claimed in claim 8, wherein at least a portion of the hook device is coated.

14. The hook device as claimed in claim 8, wherein the hook portion is connected to a telescopic pole.

15. A hook device comprising,
a body portion having a strap bent to form a loop terminating in two opposed, flat ends that can be brought together in an overlying relationship, the loop defines a first distance and a second distance;
a hook portion connected to one of the flat ends of the body portion, the hook portion is connected to a telescopic pole; and
an elongated member connected to one of the flat ends, opposite to the flat end connected to the hook portion.

16. The hook device as claimed in claim 15, further includes an elongated rod connected to the hook portion.

17. The hook device as claimed in claim 15, wherein the first distance is smaller than the second distance.

18. The hook device as claimed in claim 15, wherein the elongated member and the one of the ends, opposite to the end connected to the hook portion, are angularly connected at acute angles.

19. The hook device as claimed in claim 15, wherein the body portion, the hook portion, and the elongated member are made of aluminum material.

20. The hook device as claimed in claim 15, wherein at least a portion of the hook device is coated.
